(19) United States
(12) Patent Application Publication
(10) Pub. No.: US 2020/0192103 A1
(43) Pub. Date: Jun. 18, 2020

(54) Deflector of projection lens for eye-glass display

(71) Applicants: Fusao Ishii, (US); NTT DOCOMO, INC., Tokyo (JP)

(72) Inventors: Fusao Ishii, Pittsburgh, PA (US); Mikiko Nakanishi, Tokyo (JP); Kazuoki Ichikawa, Tokyo (JP); Yuji Aburakawa, Tokyo (JP)

(73) Assignees: Fusao Ishii, Pittsburgh, PA (US); NTT DOCOMO, INC., Tokyo (JP)

(21) Appl. No.: 16/798,918

(22) Filed: Feb. 24, 2020

Related U.S. Application Data
(60) Provisional application No. 62/809,442, filed on Feb. 22, 2019.

(30) Foreign Application Priority Data
Jun. 21, 2017 (US) PCT/US17/38523

(51) Int. Cl. G02B 27/01; G02B 5/09; G02B 3/08

(52) U.S. Cl. CPC G02B 27/0172; G02B 3/08; G02B 5/09

(57) ABSTRACT

A deflector using Fresnel prism for short throw projector is disclosed. For a compact display such as eye-glass type display requiring short throw projection lens can be made substantially shorter and simpler with a transparent Fresnel prism.

### CROSS REFERENCE TO RELATED APPLICATIONS

This application is a Non-Provisional application and claim the Priority Date of a previously filed Provisional Application 62/809,442 filed on Feb. 22, 2019, and this application is a Continuation in Part application of Ser. No. 16/252,267 filed on Jan. 19, 2019. Application Ser. No. 16/252,627 is a Continuation in Part (CIP) application of Patent Application PCT/US17/38523 filed on Jun. 21, 2017 which is a Non-Provisional filing of a Provisional Application 62/493,077 filed on Jun. 21, 2016.

### TECHNICAL FIELD

This invention relates to a see-through display for projecting an image through a second deflector or a reflector. More particularly, this invention relates to a deflector or a reflector bending light beams using Fresnel lens, Fresnel mirror, DOE (Diffractive Optical. Element), HOE (Holographic optical element).

### BACKGROUND ART

Head-mounted displays including many types of eyeglass displays are constructed with an image display device supported on eyeglass frames including waveguide to project images onto the display panel in front of the see-through lens directly in front of the eyeball. As a result, it is possible to improve the user's viewing experience and more clear images when compared with the case of projecting the image generated by the image display device directly to the lens portion.

However, the usefulness of the head-mounted display systems is limited due to the implementation of the waveguide that often causes the display system to become bulky and voluminous. Therefore, a need exists to provide new and improved head-mounted display systems that are compact and convenient to wear without using waveguide.

### SUMMARY OF THE INVENTION

A projection display projecting an image in slant angle by implementing Fresnel lens, Fresnel mirror, DOE or HOE after a set of projection lenses, so that the optical projection system is made very compact and suitable for a wearable display such as eye-glass type of display systems. Furthermore, the new and improved system as disclosed in this invention is very effective to reduce aberrations and project better images when the projected light is bent back by the Fresnel lens, Fresnel mirror, DOE or HOE as that disclosed and described in this invention.

### BRIEF DESCRIPTION OF THE DRAWINGS

FIG. 1 is a cross-sectional diagram of a projection display system 101 as a preferred embodiment of this invention.

FIG. 2 shows a detailed cross section of Fresnel lens constituting a deflector 131 according to a preferred embodiment 1.

FIG. 3 shows a variation of Fresnel lens constituting a deflector 131 according to a detailed sectional view.

FIG. 4 is a cross-sectional diagram of a projection display system 301 according to a preferred embodiment 3 and 4.

FIG. 5 shows a detailed cross section of Fresnel Mirror constituting a reflector 331 according to a preferred embodiment 3.

FIG. 6 shows a variation of Fresnel Mirror constituting a reflector 331 according to a detailed sectional view.

FIG. 7 shows that the shape of the optics described in this invention that is fitted to a face in 3D CAD to check how to fit the optics to the face and to provide sufficient clearances.

FIG. 8 shows the shape of the optics described in this invention that is fitted to a face in 3D CAD to check how to fit the optics to the face and to provide sufficient clearances.

FIGS. 9 and 10 show the cross section views of human head (gray area, 2411) at the center of eyes (2003) and the rays (2409) of projected light by a hologram (2002) wherein the clearance between the rays and the face is shown as (2410).

### DETAIL DESCRIPTIONS OF THE PREFERRED EMBODIMENTS

### First Embodiment

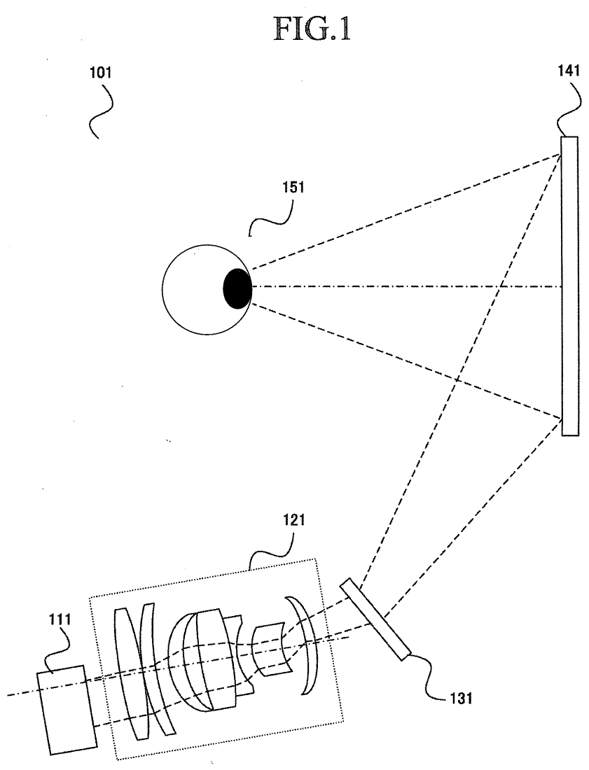

FIG. 1 is a cross-sectional diagram of a projection display system 101 according to a preferred embodiment 1. The projection display system 101 constitutes a head mounted display, i.e., an eyeglass type display.

The display system 101 includes a light source 111 that comprises light source(s) such as LED or Laser and a display device such as LCD or DMD, then project an image toward the projection lens (121). The light source 111 is a module capable of projecting an image. The light source 111 may implement an OLED that includes both light sources and a display pixel array.

A set of projection lenses 121 is implemented as a lens group for guiding the image formed by the image module 111.

An optical deflector 131 is an optical member for bending an image transmitted through the projection lenses 121 to project onto a second deflector 141. In a preferred embodiment, the optical deflector 131 is implemented as a Fresnel lens. With the arrangement that the projection lens 121 working together with the bender (131), 111 and 121, the light path will be transmitting along the temple of an eye-glass to display the image for viewing by a eyeball 151 as shown in FIG. 1. A compact head-mounted image display system implemented as an eyeglass display is therefore provided as that shown in FIG. 1 without requiring the use of bulky and massive waveguide as that usually implemented in the conventional head-mounted display devices.

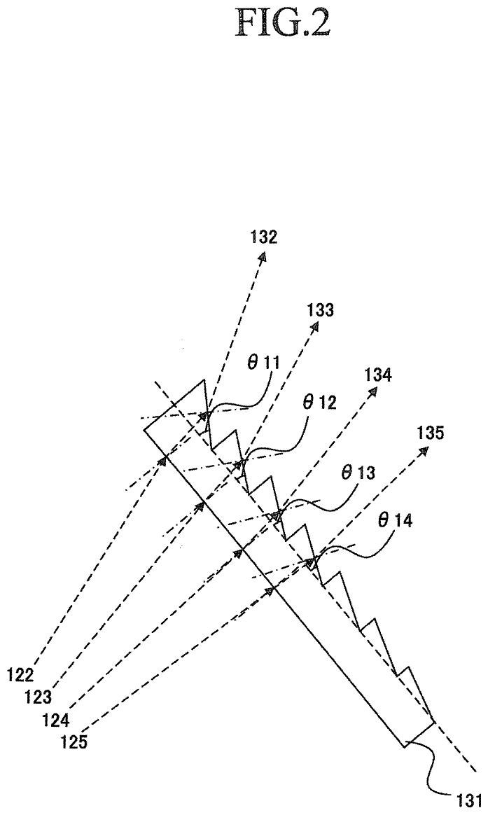

The 2nd deflector 141 is an optical member that deflects the image projected by the optical deflector 131 so that it faces the viewer's eyeball 151. The 2nd deflector 141 is a combiner that combines and projects the external light where the external light is projected from the outside scene where the eyes, e.g., 151, are watching, thus the image projected by the optical deflector 131 are projected and viewed by a viewer. With such structure, the optical element 141 is a see through optical element and a see-through display is constructed. The combiner 141 can be implemented by using a Fresnel lens, a DOE (Diffractive Optical Element) or a HOE (Holographic optical element). FIG. 2 is the details of Fresnel lens. The Fresnel lens has ridges as small as 0.1 mm, and DOE has also small ridges but as small as micron or sub-micron meter and close to the wave length of incoming light and small enough to diffract incoming light. The HOE can also be implemented with small stripes comprising of periodic change of refractive index of material and the pitch of the periodical stripes is close to the wavelength of incoming light and diffract the incoming light.

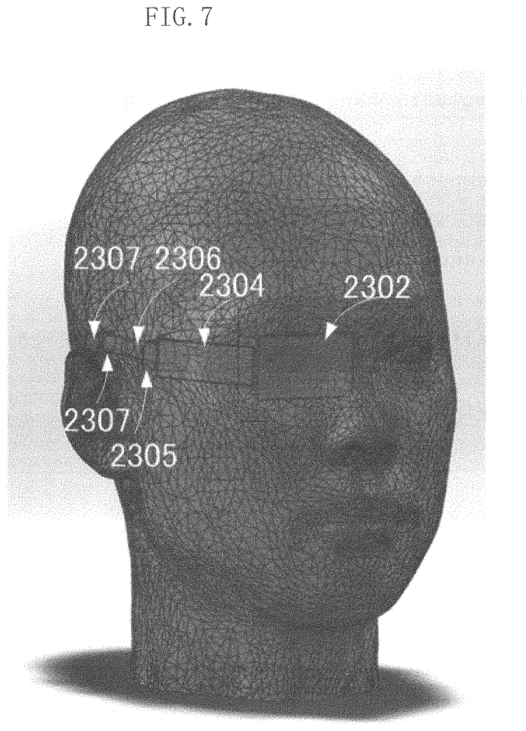

The view point is located in the eyeball 151 of the viewer, and an image is formed as that shown in FIGS. 22, 23, and 24 of a patent application Ser. No. 15/650,886 and the disclosures of the patent application Ser. No. 15/650,886 are hereby incorporated in this application by reference and are shown as FIGS. 7, 8, and 9 below. Furthermore, in FIGS. 7, 8, 9 included in this application below show the location of combiner (2302). In this picture the reflector (2304) is big and a transmissive Fresnel lens is much smaller than this. This is the purpose of this application. 2304 can be made much smaller with this invention's embodiment. As that shown in FIGS. 7, 8, 9 included in this application below, the location of combiner (2402) and eye (2410) are also clearly shown and the disclosures of the Figure and description of that patent Application is hereby incorporated by reference in this application.

FIG. 2 is a detailed cross-sectional view of Fresnel lens constituting the optical deflector 131 according to a preferred embodiment 1.

Beams 122, 123, 124, and 125 are representative lines of light rays constituting an image that passes through the projection lenses 121 and enters Fresnel lens. Beams 132, 133, 134, and 135 are representative lines of light rays constituting the image emitted from Fresnel lens and projected to the 2nd deflector 141. The Fresnel lens can be configured as a linear Fresnel lens. Fresnel lens is made of a material that transmits light such as glass or acrylic. The saw shape of the Fresnel lens faces the 2nd deflector 141. In addition, as shown in FIG. 2, the exit surface constituting the Fresnel lens has an angle of Θ11 to Θ14.

Θ 11>Θ 12>Θ 13>Θ 14

The path of beam will be described with the Beam 122 as an example. Beam 122 enters the optical deflector 131, is refracted at the entrance surface and the exit surface, and is emitted as a beam 132. The beam 132 emitted from the optical deflector 131 is directly incident on the 2nd deflector 141 without passing through another optical system.

With this configuration, it is possible to project the image incident on the Fresnel lens through the projection lenses 121 while largely bending and expanding it to the 2nd deflector 141. In addition, the size of the system can be reduced. Depending on the optical design of the entire system, Θ 11 to Θ 14 may be the same angle and an important inventive feature of this application is to make 2304 smaller with a transmissive Fresnel lens.

In the first embodiment, the optical deflector 131 is described as Fresnel lens, but DOE or HOE can be used in place of it. By combining with the DOE or HOE selected as the combiner, it is possible to reduce the aberrations of the image formed at the viewer's eye 151.

### Second Embodiment

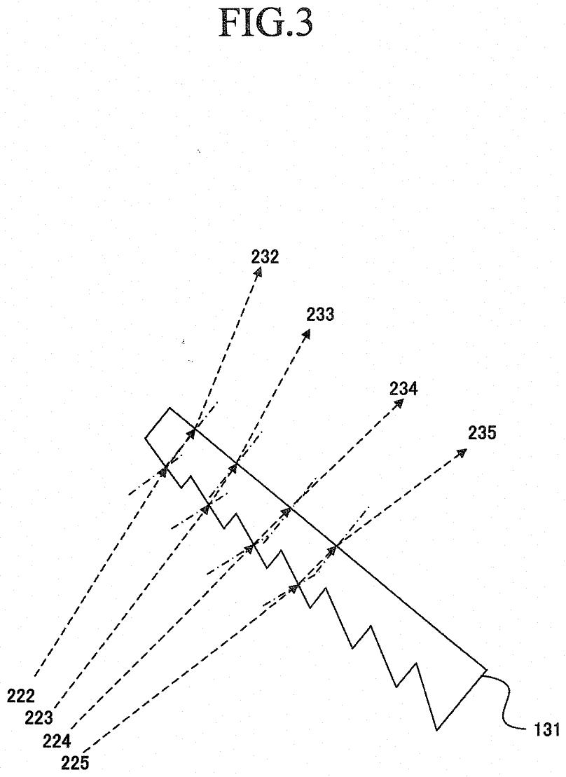

FIG. 3 shows a variation of Fresnel lens constituting a deflector 131 according to a detailed sectional view.

Beams 222, 223, 224, and 225 are representative lines of light rays constituting an image that passes through the projection lenses 121 and enters Fresnel lens. Also, Beams 232, 233, 234, and 235 are representative lines of light rays constituting the image emitted from Fresnel lens and projected to the 2nd deflector 141. The Fresnel lens can be configured as a linear Fresnel lens. The saw shape of the Fresnel lens faces the projection lenses 121 The whole purpose of this application is to make 2304 smaller with a transmissive Fresnel lens.

### Third Embodiment

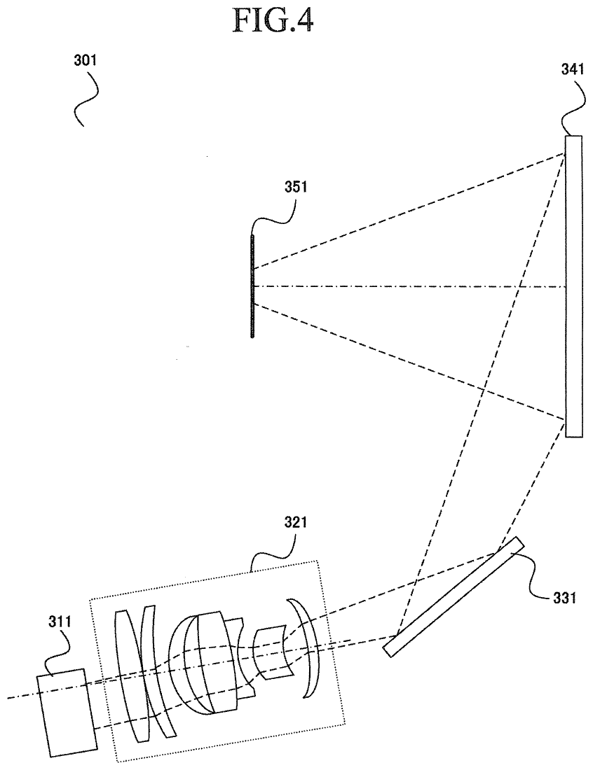

FIG. 4 is a cross-sectional diagram of a projection display system 301 according to a preferred embodiment 3.

The image module 311 corresponds to the image module 111 of embodiment 1. A set of projection lenses 321 corresponds to the projection lenses 121 of embodiment 1.

An optical reflector 331 is a reflecting optical member for bending an image transmitted through the projection lenses 321 to project onto the second deflector 341. The optical reflector 331 can be constituted by a Fresnel mirror.

The 2nd deflector 341 corresponds to the 2nd deflector 141 of embodiment 1. The view point 351 corresponds to the view point 151 of the embodiment 1.

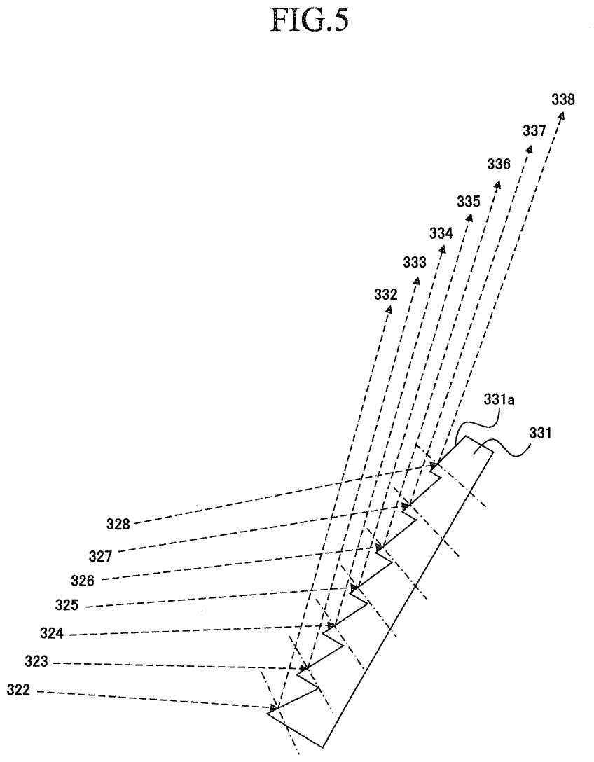

FIG. 5 shows a detail cross section of Fresnel Mirror constituting a reflector 131 according to a preferred embodiment 3.

Beams 322, 323, 324, 325, 326, 327, and 328 are representative lines of light rays constituting an image that passes through the projection lenses 321 and is incident on the Fresnel mirror. Beams 332, 333, 334, 335, 336, 337, and 338 are representative lines of light rays constituting the image reflected by the Fresnel mirror and projected to the 2nd deflector 341. The Fresnel mirror can be configured as a linear Fresnel mirror. The saw shape of the Fresnel lens is suitable for the projection lenses 321. The mirror surface 331a forming the saw shape is made of a member having optical reflection characteristics, and is formed by evaporating aluminum, for example. The angle of the saw shape may be the same angle depending on the optical design of the whole system. The optical reflector 331 does not necessarily have to be made of a material that transmits light, as the mirror surface 331 has a characteristic of reflecting light.

A path of beam will be described with the Beam 322 as an example. Beam 322 is reflected by mirror surface 331a. The reflected beam 322 exits as beam 332. The beam 332 emitted from the optical deflector 331 directly enters the 2nd deflector 341 without passing through another optical system.

With this configuration, it is possible to project the image incident on the Fresnel mirror through the projection lenses 321 to the second deflector 341 while widely bending and spreading. In addition, the size of the system can be reduced. FIG. 5 is reflection type and the others are transmissive type.

Although the optical reflector 331 has been described as a Fresnel mirror, a reflection optical system can be configured using DOE or HOE instead. By combining with the DOE or HOE selected as the combiner, it is possible to reduce the aberrations of the image formed by the viewer's eye 351.

### Forth Embodiment

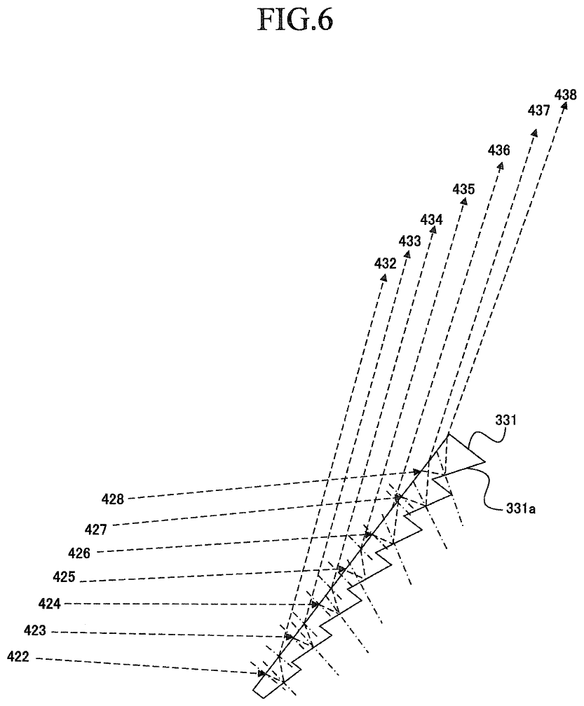

FIG. 6 shows a variation of Fresnel Mirror constituting a reflector 331 according to a detailed sectional view.

Beams 422, 423, 424, 425, 426, 427, 428 are representative lines of light rays constituting an image that passes through the projection lenses 321 and is incident on the Fresnel mirror. Beams 432, 433, 434, 435, 436, 437, 438 are representative lines of light rays constituting the image reflected by the Fresnel mirror and projected to the 2nd deflector 341.

The Fresnel mirror can be configured as a linear Fresnel mirror. The saw shape of the Fresnel lens faces the opposite direction to the projection lenses 321. The mirror surface 331b forming the saw shape is made of a member having optical reflection characteristics, and is formed by evaporating aluminum, for example. The optical reflector 331 is made of a light-transmitting material such as glass or acrylic.

Beam 422 is incident on the optical reflector 331 and is reflected by a mirror surface 331 b having an angle different from the incident surface. The reflected beam 422 passes through the entrance surface again and exits as a beam 432. This is as a first surface mirror and a second surface mirror meaning that there is a mirror which has reflective coating such as silver or aluminum. We can use the first surface for reflection meaning the surface having reflective coating is facing you, but a problem is the reflective surface can be scratched and damaged. On the other hand, we can use the second surface facing you. The surface facing you reflects about 4% of light and the reflective coating on the back side reflects 96% of light. This mirror cannot be scratched, but has a dual image due to both side reflection. In this invention purpose is not scratch free, but brightness improvement. In FIG. 5 large percent of reflected light will be blocked by the side of ridges. In FIG. 6, the light beam angle is steeper (closes to perpendicular) due to refractive index of material, the loss of light meaning blocked light by the side of ridges is less than that of FIG. 5.

FIG. 7 is an example of prior application (Fishii046, US20180373038).

An image is projected thorough a set of projection lenses (2305, 2306 and 2037) and reflected by a mirror (2304) to a combiner (2302).

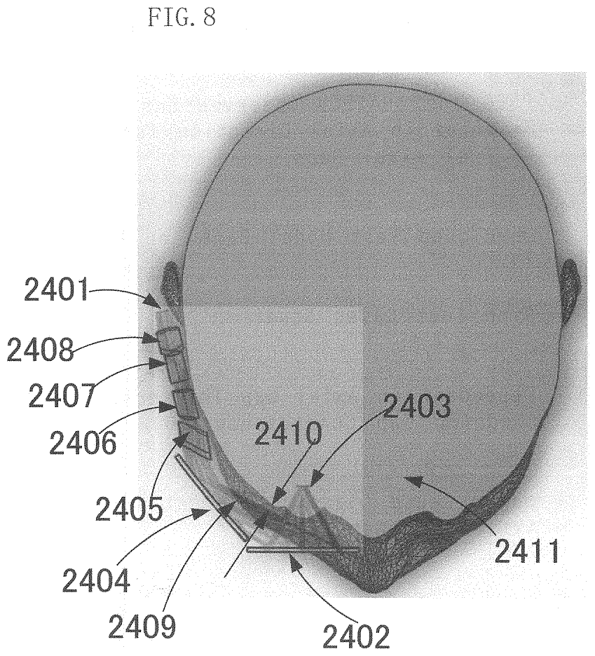

FIG. 8 is another example of prior application (Fishii046, US20180373038) showing a cross sectional view of the FIG. 8.

A display device (2401) projects an image through a set of projection lenses (2405, 2406, 2407, 2408) and the image is reflected by a mirror (2404) to a combiner (2402) The light beams of the reflected image by the mirror (2409, 2410) are focused toward the center of a viewer's (2411) eye (2403).

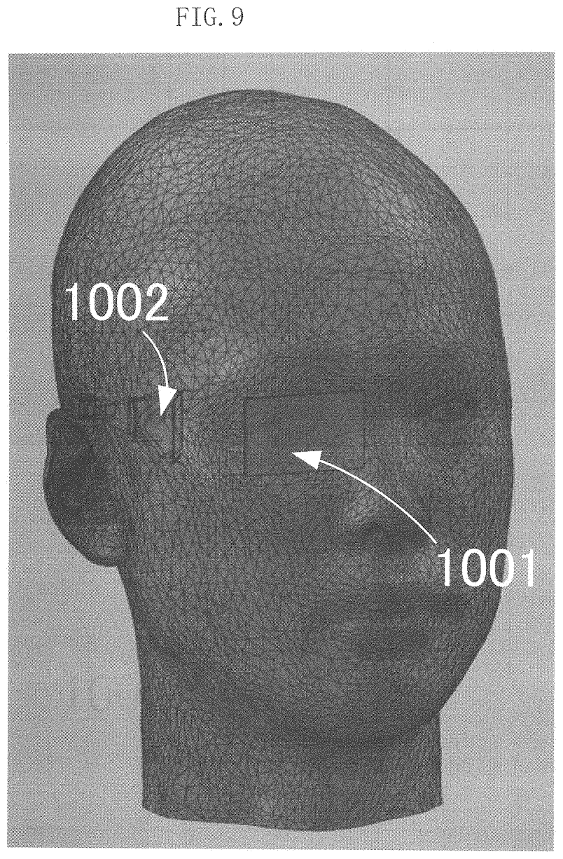

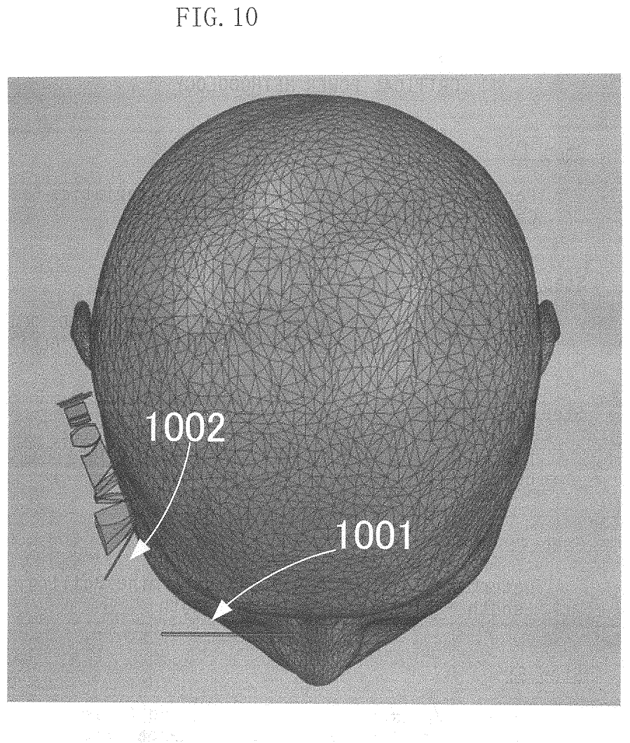

FIG. 9 and FIG. 10 illustrate examples of embodiments of this invention. An image projected to a deflector (1002) comprising Fresnel lens, DOE or HOE will be deflected toward a combiner (1001). This structure is much smaller and simpler the examples in FIG. 7 and FIG. 8.

What is claimed is:

1. A projection display system comprising:
1) light sources;
2) an image display device for forming the light generated by the light sources as image;
3) a set of projection lenses for guiding the image formed by the image display device;
4) an optical deflector composed of Fresnel lens, DOE (Diffractive Optical Element) or HOE (Holographic optical element) for bending to project the image transmitted through the projection lenses onto 2nd deflector,
5) the 2nd deflector for projecting the image projected by the optical deflector onto the eyeball of the viewer.
(It is a deflector's claim)

2. The system according to claim 1,
The optical deflector projects the image directly to 2nd deflector.

3. The system according to claim 1,
2nd deflector is a combiner which combines the image projected with external light and the optical deflector and projects it on the eyeball.

4. The system according to claim 1,
2nd deflector consists of Fresnel lens, DOE or HOE.

5. The system according to claim 1,
The Fresnel lens that constitutes the optical deflector has saw shape suitable for the projection lenses.

6. The system according to claim 1,
The Fresnel lens that constitutes the optical deflector has saw shape suitable for the 2nd deflector.

7. A projection display system comprising:
1) light sources;
2) an image display device for forming the light generated by the light sources as image;
3) a set of projection lenses for guiding the image formed by the image display device;
4) an optical reflector composed of Fresnel mirror, DOE (Diffractive Optical Element) or HOE (Holographic optical element) for bending to project the image transmitted through the projection lenses onto 2nd deflector,
5) the 2nd deflector for projecting the image projected by the optical reflector onto the viewer's eyeball.

8. The system according to claim 7,
The optical reflector projects the image directly to 2nd deflector.

9. The system according to claim 7,
2nd deflector is a combiner that combines the image projected by external light and the optical reflector and projects it on the eyeball.

10. The system according to claim 7,
2nd deflector consists of Fresnel lens, DOE or HOE.

11. The system according to claim 7,
The Fresnel mirror that constitutes the optical reflector saw shape is suitable for the projection lenses.

12. The system according to claim 7,
In the Fresnel mirror that constitutes the optical reflector, the saw shape is oriented in the opposite direction to the projection lenses.
